(19) United States
(12) Patent Application Publication
(10) Pub. No.: US 2026/0242072 A1
(43) Pub. Date: Aug. 20, 2026

(54) PAYLOAD SEPARATION DEVICE AND METHOD

(71) Applicant: REPRISE SPACE SOLUTIONS, LLC, Houston, TX (US)

(72) Inventor: Michael David Johnson, Houston, TX (US)

(21) Appl. No.: 19/643,282

(22) Filed: Apr. 9, 2026

Related U.S. Application Data
(63) Continuation-in-part of application No. 19/386,094, filed on Nov. 11, 2025.
Application No. 19/386,094 is a continuation-in-part of application No. 19/172,567, filed on Apr. 7, 2025, now Pat. No. 12,492,018.
(60) Provisional application No. 63/575,893, filed on Apr. 8, 2024.
(60) Provisional application No. 63/750,775, filed on Jan. 29, 2025.

(51) Int. Cl. B64G 1/64

(52) U.S. Cl. CPC B64G 1/642; B64G 1/645

(57) ABSTRACT

The invention relates to a payload separation system utilizing a circular arch connective mechanism for connecting and releasing a payload from a launch vehicle. The system employs interleaved voussoirs arranged in circular arch configurations on opposing rings, compressed together by a compression band to form a monolithic rigid structure with superior load distribution characteristics. The system is useful for spacecraft separation mechanisms, rocket stage separation systems, and other vehicular separation applications including submarine torpedo release mechanisms, aircraft munitions release mechanisms, and antenna deployment systems. The system addresses the fundamental paradox of separation devices that must reliably hold during launch conditions while also reliably releasing upon command, providing testable, repeatable operation without the shock forces, debris generation, or concentrated load limitations of prior art separation systems.

### CROSS-REFERENCE TO RELATED APPLICATIONS

The present application claims the benefit of U.S. Provisional Application No. 63/575,893 titled Payload Separation Device and Method, filed Apr. 8, 2024; U.S. Provisional Application No. 63/750,775 titled Payload Separation Device and Method, filed Jan. 29, 2025; U.S. Non-Provisional application Ser. No. 19/172,567 titled Payload Separation Device and Method, filed Apr. 7, 2025, (now U.S. Pat. No. 12,492,018); and U.S. CIP patent application Ser. No. 19/386,094, filed Nov. 11, 2025, all of which are incorporated herein in their entirety and referenced thereto.

### BACKGROUND OF THE INVENTION

### Field of the Invention

This invention relates generally to a payload separation system utilizing a circular arch connective mechanism for connecting and releasing a payload from a launch vehicle.

### Description of the Prior Art

Launch vehicles (a.k.a. rockets) and spacecraft have long required specialized separation systems for various situations. Launch vehicles require separation systems for separating rocket stages or payloads and spacecraft require separation systems for releasing solar arrays or antennas amongst other things.

Many separation systems have been utilized over the years but have had a variety of shortcomings. The paradox of separation devices is that they “Must Hold” and “Must Release” at different times. For example, pyrotechnic bolts have been utilized but have the shortcoming of not being testable prior to utilization as well as generating large shock forces upon separation and debris generation. Non-pyrotechnic separation nuts have also been utilized but, since the restraining nut in the system is split, the holding strength of the nut is less than a traditional nut and bolt connection. Various other systems (e.g., TiNi Frangibolt, TiNi shape memory actuators, burn wires, etc.) have been utilized with some success but all suffer from relatively weak load capability.

Other more complicated satellite separation systems have been devised. For example, the Planetary Systems Lightband Mark II and Advanced Lightband are disclosed by Holemans in U.S. Pat. No. 7,861,976. This system is extremely complex, and the load path structure is compromised since the complex securing mechanism tends to concentrate loads across multiple, small connecting interfaces.

Another, more simplified satellite separation system is disclosed by Holemans in U.S. Pat. No. 9,707,748. This system is based on a series of flexure hooks that, unfortunately, concentrate interface loads across multiple, small connecting interfaces.

Another complicated satellite separation system is disclosed in Schwarz, et. al. in JP2024097079A. This system is essentially a circular ring geometry with a collection of separation pins on the satellite side and mechanically actuated sockets on the launch vehicle side. Unfortunately, this system tends to concentrate loads on to the limited number of separation pin and socket sets.

Yet another satellite separation system is disclosed in CN106742081B which discloses an inverted clamp band structure that unfortunately minimizes the diameter of the structural ring connecting the satellite to launch vehicle thus concentrating loads.

Structural engineers consider a circular arch an extremely strong self-supporting structure. A circular form of an arch utilizes voussoirs set in a circle which are compressed with an external compression band. The external compression forces are distributed laterally in a circular path. This is essentially how wooden barrels are constructed.

The invention helps to avoid these and other problems.

### SUMMARY OF THE INVENTION

According to the teachings of the present disclosure, there is here provided a payload separation system that utilizes (i) a flyaway ring located on the payload side of the apparatus containing a set of spaced voussoirs arranged in a circular arch, (ii) a stay-behind ring located on the launch vehicle side of the apparatus containing a set of spaced voussoirs arranged in a circular arch where the voussoirs of the flyaway ring interleave with the voussoirs of the stay-behind ring, (iii) a compression band positioned around the outer diameter or inner diameter of the interleaved voussoirs that compresses the voussoirs together to form a monolithic rigid ring structure preventing separation of the rings, (iv) a releasable restraint system that holds the compression band in place until the desired deployment time and (v) separation springs that push the flyaway ring away from the stay-behind ring upon release of the compression band.

As used herein, the stay-behind ring may also be referred to as a “first ring” and the flyaway ring may also be referred to as a “second ring” in some embodiments. The first ring and second ring terminology provides generic nomenclature that encompasses various configurations where the rings may be attached to different structures depending on the application. The bolt holes in each ring are circumferentially arranged at equal angular intervals around the periphery of the respective ring for attachment to a payload or launch vehicle. The cup and cone features, when present, provide shear force transmission along a linear axis perpendicular to the deployment direction, or along multiple linear axes, between the rings. In some configurations, linear bearing guide rods may be located in the second ring (flyaway ring) and slidably received in corresponding linear bearings in the first ring (stay-behind ring), or alternatively, the linear bearing guide rods may be located in the first ring with corresponding linear bearings in the second ring, depending on the specific implementation requirements.

The main advantages of using the inventive payload separation system is that it provides immense structural strength through the distribution of loads across the circular arch elements while providing testable, repeatable, low shock, and debris-free separation of the payload from the launch vehicle.

The concept of circular arches in structures used to support heavy loads (e.g., stone bridges, wooden barrels, domed buildings) is well known in the art and is utilized to ensure maximum load distribution across the arch elements. For example, wooden barrels are formed using voussoirs (i.e., staves) set in a circle which are compressed with an external compression band (i.e., hoops). The external compression forces are distributed laterally in a circular path creating an extremely strong self-supporting structure.

The circular arch principle relies on the geometric property that compressive forces applied to the outer circumference of interleaved voussoirs are distributed uniformly around the entire circumference. This is in contradistinction to point-loaded separation systems (e.g., separation pins, flexure hooks, clamp bands) where interface loads are concentrated across multiple, small connecting interfaces that create stress concentrations and reduce overall structural capacity.

A first embodiment of the invention utilizes an outer compression band positioned around the outer diameter of the interleaved voussoirs between the flyaway ring and stay-behind ring. The flyaway ring is located on the payload side of the apparatus and contains a set of spaced voussoirs arranged in a circular arch where each voussoir has an interface surface (i.e., bolt holes) that is fastened (i.e., bolted, riveted, welded, bonded, etc.) to the payload side. The stay-behind ring is located on the launch vehicle side of the apparatus and contains a set of spaced voussoirs arranged in a circular arch where each voussoir has an interface surface (i.e., bolt holes) that is fastened (i.e., bolted, riveted, welded, bonded, etc.) to the launch vehicle side. The voussoirs of the flyaway ring interleave with the voussoirs of the stay-behind ring forming a monolithic rigid ring structure when compressed together by the outer compression band. The outer compression band includes chamfered surfaces that seat against chamfered cutouts on the outer diameter of the interleaved voussoirs providing geometric constraint preventing axial axis separation of the flyaway and stay-behind rings. It is important to note that the circular arch configuration of the interleaved voussoirs with the compression band produces an extremely high strength to weight ratio structure which is highly desirable for spacecraft launch purposes. The compression band is constrained by a releasable restraint system (e.g., gear motor with screw mechanism, separation nut, pyrotechnic release, burn wire, shape memory alloy, etc.) that holds the compression band in place until the desired deployment time. Any convenient releasable restraint system may be utilized to constrain and release the compression band. It is not intended to limit the invention to any particular releasable restraint system. Finally, after release of the compression band, separation springs embedded in the stay-behind ring push the flyaway ring away from the stay-behind ring by applying the separation force vector along the axial axis thereby providing controlled separation with minimal tipoff rates.

A second embodiment of the invention incorporates cup and cone features in addition to the outer compression band configuration of the first embodiment. The cup features are formed as recessed portions on the mating faces of voussoirs on one of the rings, while the cone features are formed as corresponding protruding portions on the mating faces of voussoirs on the opposing ring. When the flyaway ring and stay-behind ring are engaged, the cones seat into the cups to provide positive engagement surfaces that resist lateral forces along linear axes during launch conditions. The cup and cone features provide increased shear force transmission between the stay-behind and flyaway rings along a linear axis or along multiple linear axes depending on the configuration. This embodiment also provides an alternate voussoir geometry that enables straight line bolt hole positioning where the number of voussoirs on each ring is equal to one half of the number of bolt holes in each ring (also referred to as half of the number of bolt holes) and the angular width of each voussoir element is equal to 360/(number of bolt holes*0.5) degrees.

A third embodiment of the invention utilizes an inner (chamfered) compression band positioned on the internal diameter between the stay-behind ring and flyaway ring, replacing the function of the external compression band of the first and second embodiments. The inner compression band is constrained by a radial gear motor driving a screw into engagement with a toggle assembly that expands the inner compression band against the inner diameter of the interleaved voussoirs. The toggle assembly may comprise a plurality of linkage arms connected at pivot points that convert rotational motion of the screw into radial expansion or contraction of the inner compression band. When the screw is driven inward by the radial gear motor, the linkage arms pivot outward to expand the inner compression band against the inner diameter of the voussoirs. Conversely, when the radial gear motor retracts the screw, the linkage arms pivot inward causing the inner compression band to contract and release the voussoirs. The toggle mechanism provides mechanical advantage such that a relatively small force applied by the radial gear motor produces a larger radial force on the inner compression band. The inner compression band may include chamfered surfaces similar to the external compression band that seat against chamfered cutouts on the inner diameter of the interleaved voussoirs providing geometric constraint preventing axial axis separation of the flyaway and stay-behind rings. The third embodiment may also incorporate the cup and cone features of the second embodiment. Any convenient actuation method may be utilized to control the inner compression band (e.g., radial gear motor with toggle assembly, separation nut, pyrotechnic release, burn wire, shape memory alloy, etc.). It is not intended to limit the invention to any particular actuation method.

A peculiar and extremely useful property of all embodiments is the incorporation of a draft angle between the opposing voussoir faces that enables voussoir separation in a manner similar to the draft angle introduced between an injection mold and its separating part. The draft angle refers to the angle of the contacting faces of the interleaved voussoirs where the interleaved voussoirs have a wider space between the tops of the interleaved voussoirs and narrower spacing between the interleaved voussoir bases. This feature has the effect of enabling separation and guaranteeing separation of interleaved voussoirs since a small vertical motion of the flyaway ring from the stay-behind ring causes a relative face separation thus reducing risk of jamming. Linear bearings and guide rods maintain a normal vector separation with no tilting or rotation between the flyaway ring and stay-behind ring that enhance the draft feature functionality.

A further benefit of the inventive device is the utilization of radial ejection pins to urge the compression band away from the separating stay-behind ring and flyaway ring while simultaneously restraining the compression band from ejection from the stay-behind ring. Radial ejection pins are captured in a groove formed on the inner diameter of the compression band which prevents the compression band from flying away from the stay-behind ring after release of the compression band. This eliminates any debris generation concerns during satellite deployment.

The inventive device is particularly suited for applications beyond satellite separation including submarine torpedo release mechanisms, submarine door release mechanisms, underwater cable release mechanisms, aircraft bomb release mechanisms, fuel tank release mechanisms, landing gear release mechanisms, munitions release mechanisms, aircraft door release mechanisms, rocket stage separation systems, payload separation systems, solar array release mechanisms, and antenna release mechanisms amongst other things. The circular arch principle with interleaved voussoirs and compression band provides superior load distribution and reliable separation for any application requiring a “Must Hold” and “Must Release” capability.

Descriptions of certain illustrative aspects are described herein in connection with the figures. These aspects are indicative of various non-limiting ways in which the invention may be utilized, all of which are intended to be within the scope of the invention.

Other advantages, emerging properties, and features will become apparent from the following detailed disclosure when considered in conjunction with the associated figures that are also within the scope of the disclosure.

### BRIEF DESCRIPTION OF THE DRAWINGS

A more complete understanding of the invention and the many attendant advantages thereof will be readily appreciated as the same becomes better understood by reference to the following detailed description, when considered in connection with the accompanying drawings wherein:

FIG. 1 is a view of the first embodiment while engaged.

FIG. 2 is a view of the first embodiment while disengaged.

FIG. 3 is a simplified cutaway view of the compression band and interleaved voussoirs while engaged.

FIG. 4 is a simplified cutaway view of the compression band and interleaved voussoirs while disengaged.

FIG. 4A is a view of the voussoir draft angle detail.

FIG. 4B is a view of the voussoir draft angle plane detail.

FIG. 5 is a top cutaway view of the compression band radial ejection pin operation.

FIG. 6 is view of a second embodiment while disengaged incorporating cup and cone features.

FIG. 7 is a detailed view of the cup and cone features while disengaged.

FIG. 8 is a view of the third embodiment while engaged.

FIG. 9 is a view of the third embodiment while disengaged.

### DESCRIPTION OF THE PREFERRED EMBODIMENT

The inventive device utilizes a geometric constraining method of attachment between a satellite flyaway ring and a launch vehicle stay-behind ring. The primary constraining mechanism uses interleaved voussoirs between the flyaway and stay-behind rings that are compressed together by an outer compression band. The compressed voussoirs form a monolithic rigid ring with superior axial and linear strength over current separation systems. The compressed voussoir configuration also provides axial (i.e., launch direction) restraint due to friction. The invention provides a large mechanical advantage since a small tension force in the compression band imposes a large clamping force between the flyaway and stay-behind rings.

The secondary constraining method of the invention (in the axial or launch direction) utilizes chamfered cutouts on the outer diameter of the interleaving voussoirs between the flyaway and stay-behind rings that seat on a chamfered compression band preventing axial axis separation of the flyaway and stay-behind rings.

Conventional compression springs are used to separate and propel the flyaway ring with attached spacecraft away from the stay-behind ring/launch vehicle as soon as the chamfered compression band is released. The interleaved voussoirs prevent rotation of the flyaway ring in all three axes as well as lateral shifting in two axes thus leaving only translation possible in the axial direction (i.e., the deployment direction). The interleaved voussoirs also function as guides during deployment inherently minimizing tipoff rates.

Additionally, a draft angle cut can be introduced between the opposing voussoir faces that enables voussoir separation in a manner like the draft angle introduced between an injection mold and its separating part.

Linear bearings may also be utilized to maintain parallel relationship (i.e., prevent relative tilting) between the separating stay-behind and flyaway interleaved voussoirs rings to prevent jamming during separation due to a wedging effect between the separating voussoirs.

The chamfered compression band is preferably constrained via an electric motor actuated screw mechanism using a brushless motor with a planetary reduction gearbox capable of operating in a low or zero pressure environment but can be of any motive power deemed convenient for the application (e.g., brushed electric motor, pneumatic motor, hydraulic motor, etc.).

The chamfered compression band may also be constrained by a separation nut, well known in prior art, that can be actuated by various means (e.g., pyrotechnic, shape memory alloy, burn wire, paraffin expansion, frangible bolt, etc.). For example, a TiNi separation nut is commercially available to perform this function.

Another advantage offered by the invention is the incorporation and containment of the separation springs within the volume of the voussoir elements.

The invention also permits the utilization of radial ejection pins to urge the compression band away from the separating stay-behind ring and flyaway ring while simultaneously restraining the compression ring from ejection from the stay-behind ring. Radial ejection pins are captured in a groove formed on the inner diameter of the compression band which prevents the compression band from flying away from the stay-behind ring after release of the compression band.

The invention also permits utilization of cup and cone features on the stay-behind and flyaway rings that provide shear force (i.e., lateral forces perpendicular to the deployment direction) transmission between the stay-behind and flyaway rings of the invention.

Furthermore, the invention permits utilization of an inner compression band (replacing the function of the previous outer chamfered compression band) located on the internal diameter between the stay-behind and flyaway rings that provides a primary constraining method of the invention (in the axial or launch direction) that utilizes chamfered cutouts on the inner diameter of the interleaving voussoirs between the flyaway and stay-behind rings that seat on an inner compression band preventing axial axis separation of the flyaway and stay-behind rings.

Utilization of the combination of the interleaved arch elements combined with a chamfered compression band in a separation system provides the following advantages: 1. The maximum strength of the arch structure can be utilized via distribution of loads across the voussoir elements, 2. The system may be tested for “Must Hold” (i.e. launch period) and “Must Release” (i.e. deployment period) states any number of times and reset, 3. Disconnection of “Must Hold” and “Must Release” state risk sources, and 4. Increased reliability by minimizing the part count of the system.

Some other applications of the separation system include submarine torpedo release mechanisms, submarine door release mechanisms, and underwater cable release mechanisms. Some aircraft applications are bomb release mechanisms, fuel tank release mechanisms, landing gear release mechanisms, munitions release mechanisms and aircraft door release mechanisms. Some launch vehicle applications include rocket stage separation systems, payload separation systems and landing gear release mechanisms. Some spacecraft applications include solar array release mechanisms and antenna release mechanisms amongst other things.

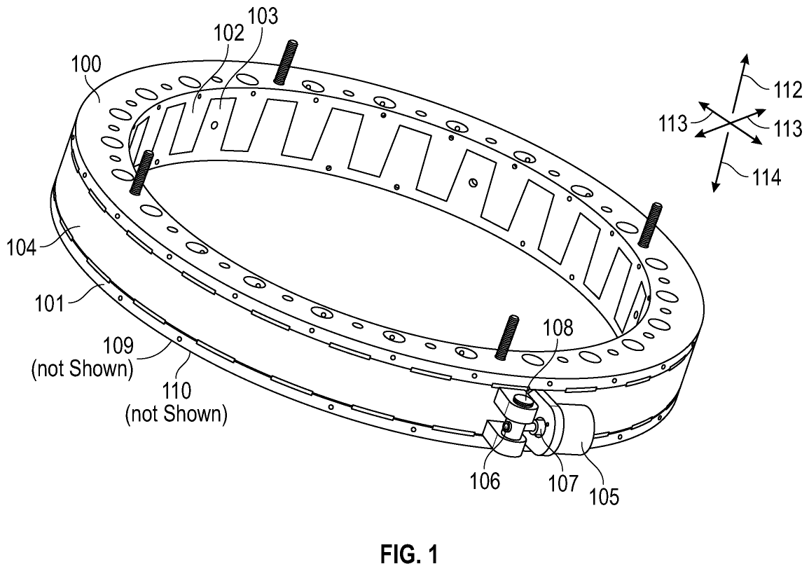

In a first embodiment illustrated in FIGS. 1 through 5, the satellite separation system utilizes an outer compression band 104 positioned around the outer diameter of the interleaved voussoirs to compress the flyaway ring 100 and stay-behind ring 101 together.

In FIG. 1 the inventive device utilizes a geometric constraining method of attachment between flyaway ring 100 and stay-behind ring 101. The primary constraining mechanism uses voussoir 102 on flyaway ring 100 and voussoir 103 on stay-behind ring 101 that are compressed together by an outer compression band 104.

Outer compression band 104 is constrained by gear motor 105 driving nut 107 to release screw 106 which is received by pin 108. This configuration permits the release of compression band 104 by operation of motor 105.

Spring housings 109 (not shown in FIG. 1) embedded in stay-behind ring 101 contain conventional separation compression springs 110 (not shown in FIG. 1) that react against flyaway ring 100.

Compressed voussoirs 102 and 103 form a monolithic rigid ring with superior axial axis 112 and linear axes 113 strength over current separation systems. The compressed voussoir configuration provides axial axis 112 (i.e., launch direction) restraint due to friction in combination with the geometric constraint provided by the compression band 104 chamfered recess into the groove formed between flyaway ring 100 against stay-behind ring 101. Axis 114 is constrained in compression of flyaway ring 100 against stay-behind ring 101.

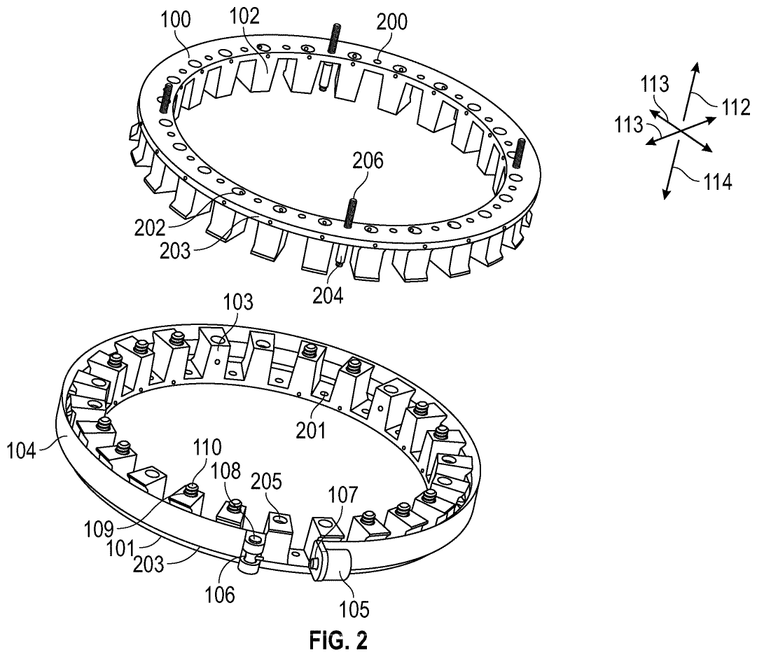

In FIG. 2 compression band 104 is released via gear motor 105 unscrewing nut 107 releasing screw 106 held by pin 108 releasing flyaway ring 100 from stay-behind ring 101. Separation springs 110 located in recesses 109 push flyaway ring 100 from stay-behind ring 101. Bolt holes 200 are bolt through holes to attach a payload (not shown) to flyaway ring 100. Bolt holes 201 are bolt through holes to attach stay-behind ring 101 to a launch vehicle (not shown). Corresponding clearance holes 202 are provided in flyaway ring 100 at the mating face of the voussoirs 102 and stay-behind ring 101 at the mating face of the voussoirs 103 to accommodate bolt heads from bolts in holes 200 and 201 respectively. Note that springs 110 may be restrained using pins or wires in holes 203 to keep springs 110 from escaping the assembly after release. Additional springs 110 may be added to clearance holes 202 and restrained by pins in holes 203 on the flyaway ring to provide additional separation spring force if desired.

At least three (preferably four) linear bearing guide rods 204 located in flyaway ring 100 slide through linear bearings 205 in stay-behind ring 101 (linear bearing guide rods 204 and linear bearings 205 are spaced equally around the periphery of flyaway ring 100 and stay-behind ring 101) to prevent relative tipping between flyaway ring 100 and stay-behind ring 101 thus preventing jamming between flyaway ring 100 and stay-behind ring 101. The top of linear bearing guide rod 204 has threads 206 that interface with the satellite attached to flyaway ring 100. In alternative configurations, the linear bearing guide rods 204 may be located in the second ring (flyaway ring 100) with corresponding linear bearings 205 in the first ring (stay-behind ring 101), or vice versa, depending on the specific implementation requirements.

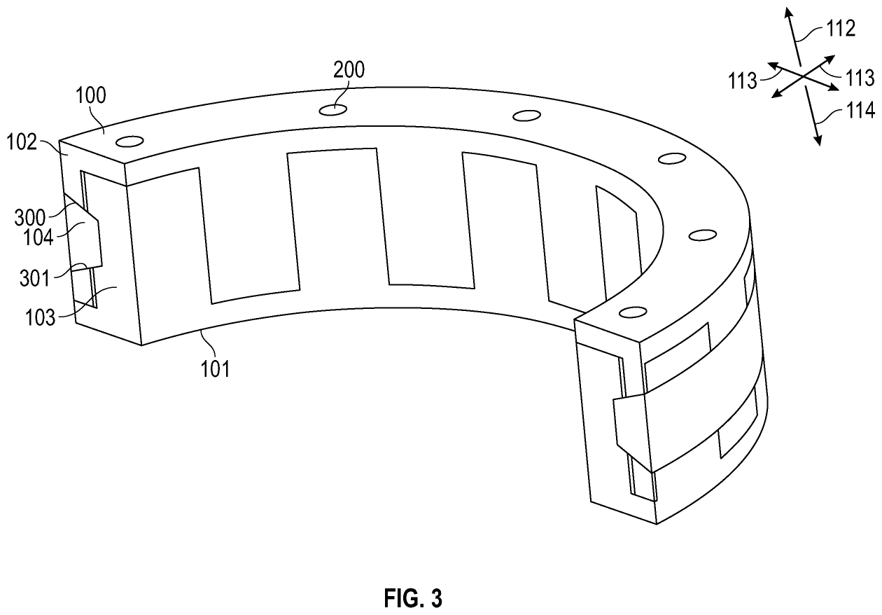

FIG. 3 illustrates a smaller diameter and simplified cutaway of the secondary constraining method of the invention (in the axial or launch direction axis 112) which utilizes chamfered cutouts 300 on the outer diameter of both flyaway voussoirs 102 and chamfered cutouts 301 on the outer diameter of stay-behind voussoirs 103 between flyaway ring 100 and stay-behind ring 101 that seat on chamfered compression band 104 preventing axial axis 112 separation of flyaway ring 100 and stay-behind ring 101.

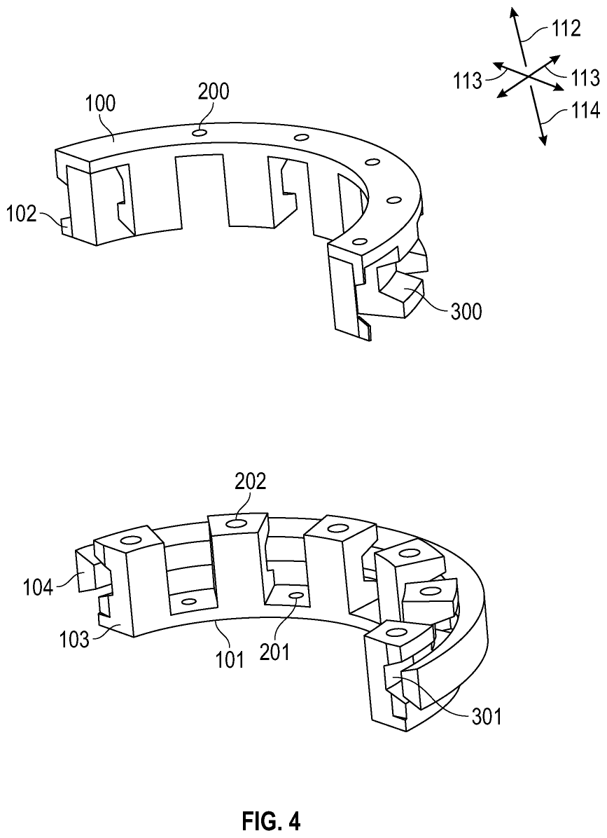

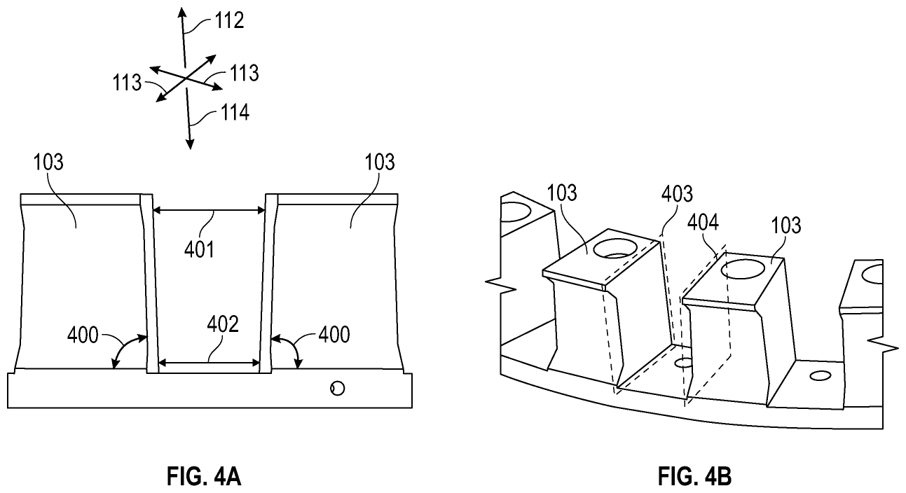

FIG. 4 illustrates a smaller diameter and simplified cutaway of the secondary constraining method after separation of the invention (in the axial or launch direction axis 112) which utilizes chamfered cutouts 300 on the outer diameter of both flyaway voussoirs 102 and chamfered cutouts 301 on the outer diameter of stay-behind voussoirs 103 between flyaway ring 100 and stay-behind ring 101 that seat on chamfered compression band 104 preventing axial axis 112 separation of flyaway ring 100 and stay-behind ring 101.

Conventional compression springs 110 are used to separate and propel flyaway ring 100 with attached spacecraft away from the launch vehicle as soon as chamfered compression band 104 is released. Interleaved voussoirs 102 and 103 prevent rotation of flyaway ring 100 in all three axes as well as lateral shifting in two axes thus leaving only translation possible in axial direction 112 (i.e., the deployment direction). Interleaved voussoirs 102 and 103 also function as guides during deployment in deployment axis 112 inherently minimizing tipoff rates. As stated earlier, at least three (preferably four) linear bearing guide rods 204 located in flyaway ring 100 slide through linear bearings 205 in stay-behind ring 101 (linear bearing guide rods 204 and linear bearings 205 are spaced equally around the periphery of flyaway ring 100 and stay-behind ring 101) to prevent relative tipping between flyaway ring 100 and stay-behind ring 101 thus preventing jamming between flyaway ring 100 and stay-behind ring 101. The top of linear bearing guide rod 204 has threads 206 that interface with the satellite attached to flyaway ring 100.

Chamfered compression band 104 is preferably constrained via a motor assembly where gear motor 105 is an axially-oriented brushless motor with a planetary reduction gearbox capable of operating in a low or zero pressure environment but can be of any motive power deemed convenient for the application (e.g., brushed electric motor, pneumatic motor, hydraulic motor, etc.). Gear motor 105 used with the outer compression band 104 in the first embodiment is distinct from radial gear motor 801 used in the third embodiment, which is a radially-oriented gear motor that operates the toggle assembly 803 for the inner compression band 800.

In addition, gear motor 105 could be replaced with a separation nut, well known in prior art, utilizing a pyrotechnic release system, a burn wire release mechanism, a shape memory alloy release mechanism or any other convenient release mechanism that will hold nut 107 with sufficient tension to compress and hold chamfered compression band 104 attached to screw 106 and pin 108 and release, upon electrical command, nut 107 which releases the tension on chamfered compression band 104 causing chamfered compression band 104 to expand and release flyaway ring 100 from stay-behind ring 101.

FIG. 4A illustrates a further feature of the inventive device in the application of a draft angle 400 between interleaved voussoirs 102 (not shown) and 103 in separation direction 112. Draft angle 400 refers to the angle of the contacting faces of the interleaved voussoirs 102 and 103 where the interleaved voussoirs 102 and 103 have a wider space 401 between the tops of the interleaved voussoirs 102 and 103 and narrower spacing 402 between the interleaved voussoirs 102 and 103 bases. This feature has the effect of guaranteeing separation of interleaved voussoirs 102 and 103 since a small vertical motion of flyaway ring 100 from stay-behind ring 101 causes a relative face separation (thus reducing risk of jamming) like a plastic part ejection from a drafted wall mold. Linear bearings 205 and guide rods 204 maintain a normal vector separation (with no tilting or rotation) between in direction 112 flyaway ring 100 from stay-behind ring 101 that enhance the draft feature functionality.

FIG. 4B illustrates the planes 403 and 404 formed by applying draft angle 400 to voussoirs 102 (not shown) and 103.

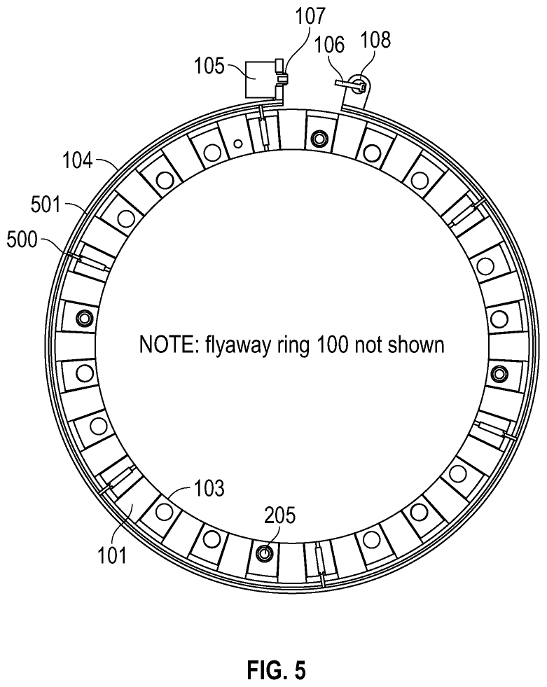

FIG. 5 is a top cutaway view of the utilization of radial ejection pins 500 to urge compression band 104 away from the separating stay-behind ring 101 and flyaway ring 100 while simultaneously restraining compression band 104 from ejection from stay-behind ring 101. Radial ejection pins 500 are captured in groove 501 formed on the inner diameter in compression band 104 which prevent compression band 104 from flying away from stay-behind ring 101 after release of compression band 104.

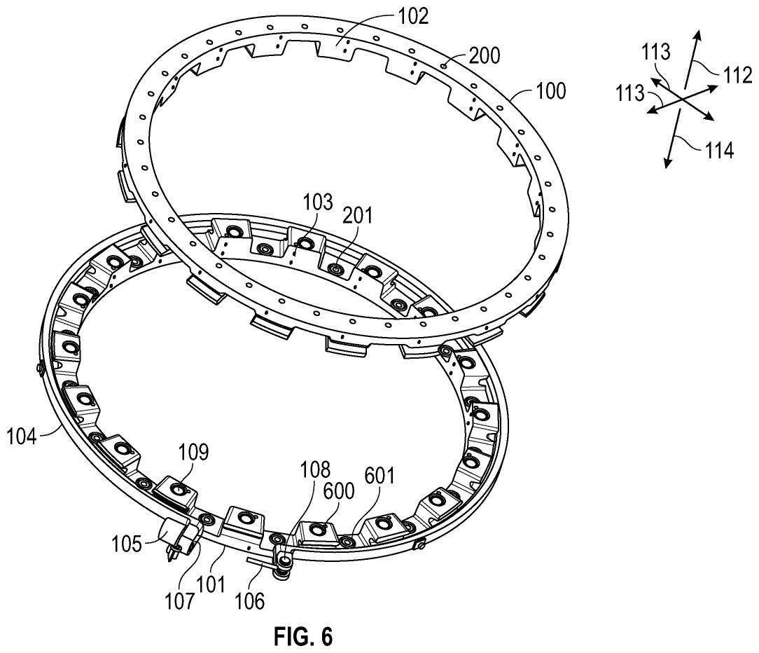

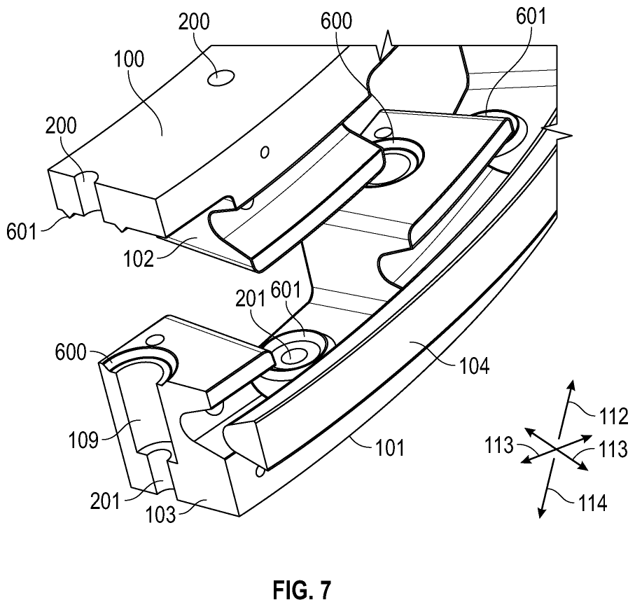

In a second embodiment illustrated in FIGS. 6 and 7, the satellite separation system incorporates cup 600 and cone 601 features in addition to the outer compression band 104 configuration of the first embodiment. The second embodiment also provides an alternate voussoir geometry that enables straight line bolt hole positioning.

FIG. 6 illustrates an alternate geometry that provides straight line bolt hole 200 and 201 positioning between stay-behind 101 and flyaway 100 rings. The number of voussoirs 102 and 103 on each stay-behind 101 and flyaway 100 rings are equal to one half of the number of bolt holes 200 and 201 in each of the stay-behind 101 and flyaway 100 rings. The angular width of each of the voussoir elements 102 and 103 is equal to 360/(number of bolt holes*0.5) degrees. The previous embodiment illustrated in FIGS. 1 through 5 utilizes voussoir elements 102 and 103 with an angular width equal to 360/(number of bolt holes) degrees. This situation causes the bolt holes 200 and 201 to be staggered equal to 360/(number of bolt holes*2) degrees and not in line with each other.

Also illustrated in FIG. 6 are added cup 600 and cone 601 features that provide increased shear force transmission along linear axes 113 between the stay-behind and flyaway rings.

FIG. 7 is a detailed cutaway illustration of cup 600 and cone 601 features as incorporated into the invention.

In some embodiments, cups 600 may be formed as recessed portions on the mating faces of voussoirs on one of the rings, while cones 601 may be formed as corresponding protruding portions on the mating faces of voussoirs on the opposing ring. When flyaway ring 100 and stay-behind ring 101 are engaged, cones 601 seat into cups 600 to provide positive engagement surfaces that resist lateral forces along linear axes 113 during launch conditions. The cup and cone features may be positioned on the mating faces of flyaway voussoirs 102 and stay-behind voussoirs 103.

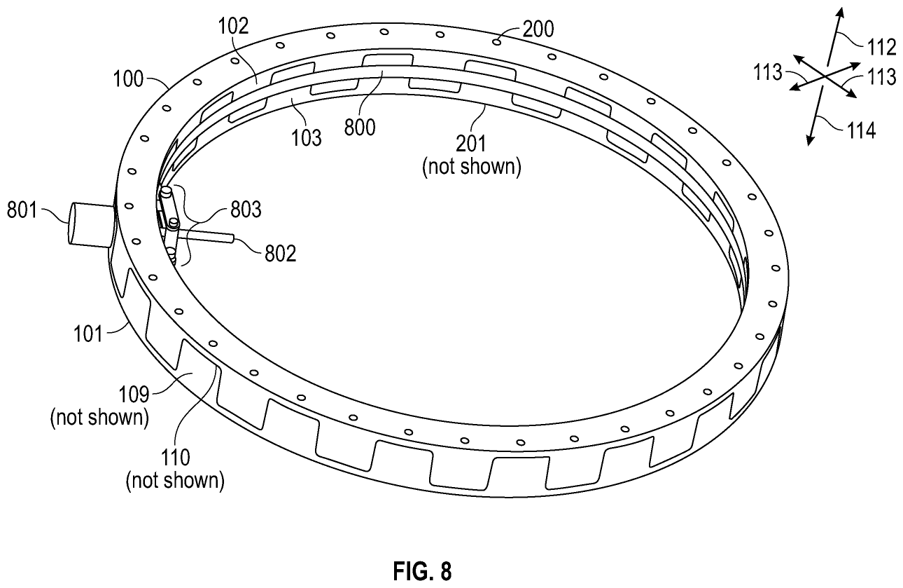

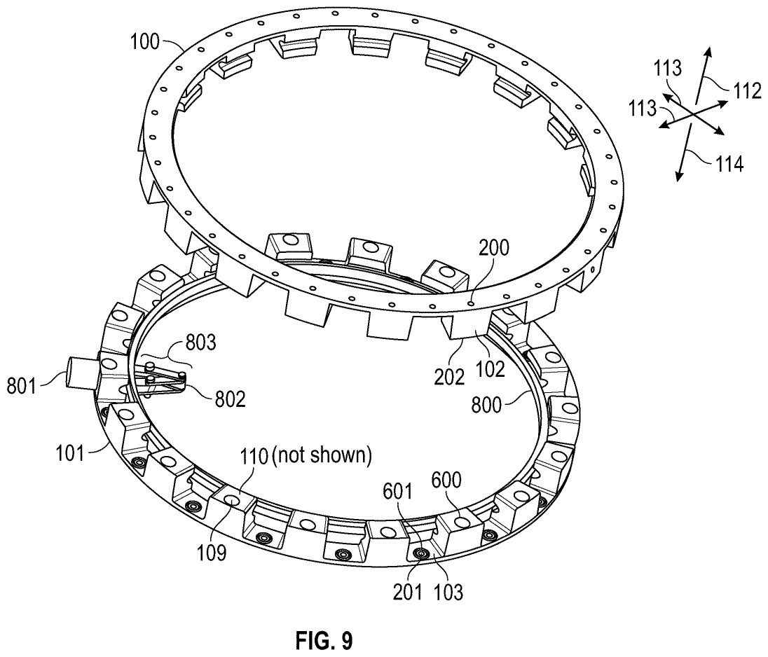

In a third embodiment illustrated in FIGS. 8 and 9, the satellite separation system utilizes an inner compression band 800 positioned on the internal diameter between the stay-behind ring 101 and flyaway ring 100, replacing the function of the external compression band 104 of the first and second embodiments. The third embodiment may also incorporate the cup 600 and cone 601 features of the second embodiment.

FIG. 8 illustrates an alternate geometry that provides an inner compression band 800 in addition to straight line bolt hole 200 and 201 positioning between stay-behind 101 and flyaway 100 rings. The number of voussoirs 102 and 103 on each stay-behind 101 and flyaway 100 rings are equal to one half of the number of bolt holes 200 and 201 in each of the stay-behind 101 and flyaway 100 rings. The angular width of each of the voussoir elements 102 and 103 is equal to 360/(number of bolt holes*0.5) degrees as in FIG. 6.

In FIG. 8 the inventive device utilizes a geometric constraining method of attachment between flyaway ring 100 and stay-behind ring 101. The primary constraining mechanism uses voussoir 102 on flyaway ring 100 and voussoir 103 on stay-behind ring 101 that are compressed together by an inner compression band 800.

Inner compression band 800 is constrained by radial gear motor 801 driving screw 802 in toggle assembly 803. This configuration permits the setting and release of inner compression band 800 by operation of radial gear motor 801.

Toggle assembly 803 may comprise a plurality of linkage arms connected at pivot points that convert rotational motion of screw 802 into radial expansion or contraction of inner compression band 800. When screw 802 is driven inward by radial gear motor 801, the linkage arms pivot outward to expand inner compression band 800 against the inner diameter of voussoirs 102 and 103. Conversely, when radial gear motor 801 retracts screw 802, the linkage arms pivot inward causing inner compression band 800 to contract and release the voussoirs. The toggle mechanism provides mechanical advantage such that a relatively small force applied by radial gear motor 801 produces a larger radial force on inner compression band 800.

In addition, radial gear motor 801 and toggle assembly 803 may be replaced with alternative actuation methods similar to those described for the external compression band embodiment. For example, a separation nut utilizing a pyrotechnic release system, a burn wire release mechanism, a shape memory alloy release mechanism, or any other convenient release mechanism may be used to actuate toggle assembly 803 or to directly control the expansion and contraction of inner compression band 800.

Spring housings 109 (not shown in FIG. 8) embedded in stay-behind ring 101 contain conventional separation compression springs 110 (not shown in FIG. 8) that react against flyaway ring 100.

Compressed voussoirs 102 and 103 form a monolithic rigid ring with superior axial axis 112 and linear axes 113 strength over current separation systems. The compressed voussoir configuration provides axial axis 112 (i.e., launch direction) restraint due to friction in combination with the geometric constraint provided by the inner compression band 800 chamfered recess into the groove formed between flyaway ring 100 against stay-behind ring 101. Axis 114 is constrained in compression of flyaway ring 100 against stay-behind ring 101.

Inner compression band 800 may include chamfered surfaces similar to external compression band 104. In some embodiments, chamfered cutouts may be provided on the inner diameter of voussoirs 102 and 103, analogous to chamfered cutouts 300 and 301 on the outer diameter described for the first embodiment. Inner compression band 800 seats against these inner chamfered cutouts to provide geometric constraint preventing axial axis 112 separation of flyaway ring 100 and stay-behind ring 101.

In FIG. 9 inner compression band 800 is released (contracted) via release radial gear motor 801 driving screw 802 in toggle assembly 803 releasing flyaway ring 100 from stay-behind ring 101. Separation springs 110 (not shown) located in recesses 109 push flyaway ring 100 from stay-behind ring 101. Bolt holes 200 are bolt through holes to attach a payload (not shown) to flyaway ring 100. Bolt holes 201 are bolt through holes to attach stay-behind ring 101 to a launch vehicle (not shown). Corresponding clearance holes 202 are provided in flyaway ring 100 at the mating face of the voussoirs 102 and stay-behind ring 101 at the mating face of the voussoirs 103 to accommodate bolt heads from bolts in holes 200 and 201 respectively. Note that springs 110 (not shown) may be restrained using pins or wires in holes 203 (as in FIG. 1) to keep springs 110 (not shown) from escaping the assembly after release. Additional springs 110 (not shown) may be added to clearance holes 202 and restrained by pins in holes 203 (as in FIG. 1) on the flyaway ring to provide additional separation spring force if desired.

Also illustrated in FIG. 9 are added cup 600 and cone 601 features (only indicated in FIG. 9 on stay-behind ring 101 for clarity) that provide increased shear force transmission along linear axes 113 between the stay-behind and flyaway rings (as in FIG. 6 and FIG. 7).

The third embodiment incorporating inner compression band 800 may be combined with features from the first embodiment. For example, linear bearing guide rods 204 and linear bearings 205 may be utilized with inner compression band 800 to prevent relative tipping between flyaway ring 100 and stay-behind ring 101 during separation. Similarly, draft angle 400 between interleaved voussoirs 102 and 103 may be incorporated in the third embodiment to facilitate separation and reduce the risk of jamming.

Utilization of the combination of the interleaved arch elements 102 and 103 combined with chamfered compression band 104 or inner compression band 800 in a separation system provides the following advantages: 1. The maximum strength of an arch structure can be utilized, 2. The system may be tested for “Must Hold” (i.e. launch period) and “Must Release” (i.e. deployment period) states any number of times and, 3. Operational separation of “Must Hold” and “Must Release” state risk sources, and 4. Increased reliability by minimizing the part count of the system.

The invention provides significant advantages over prior art separation systems. Unlike pyrotechnic bolts which are not testable prior to utilization and generate large shock forces upon separation along with debris generation, the inventive device may be tested repeatedly for both “Must Hold” and “Must Release” states without degradation. The interleaved voussoir configuration with compression band 104 or inner compression band 800 provides a clean separation without shock forces or debris.

In contrast to non-pyrotechnic separation nuts where the restraining nut is split and thus provides less holding strength than a traditional nut and bolt connection, the inventive device utilizes the full structural strength of the circular arch formed by compressed voussoirs 102 and 103. The distribution of loads across the voussoir elements provides superior axial axis 112 and linear axes 113 strength compared to systems that concentrate loads across multiple small connecting interfaces.

The invention overcomes the limitations of complex systems such as the Planetary Systems Lightband which concentrate interface loads across multiple small connecting interfaces. The inventive device distributes loads uniformly around the circumference of the interleaved voussoirs 102 and 103, utilizing the inherent strength of the circular arch structure.

Unlike separation pin and socket systems that concentrate loads on a limited number of connection points, the inventive device provides continuous load distribution through the interleaved voussoirs 102 and 103 compressed by compression band 104 or inner compression band 800. The chamfered cutouts 300 and 301 seating on the chamfered compression band provide geometric constraint in addition to frictional restraint.

The incorporation of draft angle 400 between interleaved voussoirs 102 and 103 guarantees separation without jamming, a feature not present in prior art systems. Linear bearing guide rods 204 and linear bearings 205 further ensure reliable separation by maintaining parallel alignment between flyaway ring 100 and stay-behind ring 101 during deployment.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A satellite separation system, said satellite separation system comprising in combination:
a first ring comprising a plurality of first bolt holes;
a second ring comprising a plurality of second bolt holes; and
an inner compression band,
wherein said first ring comprises a set of spaced voussoirs arranged in a circular arch,
said second ring comprises a set of spaced voussoirs arranged in a circular arch,
wherein said spaced voussoirs of said first ring interleave with said second ring spaced voussoirs,
said inner compression band is positioned on an internal diameter between said first ring and said second ring and compresses said voussoirs together to prevent separation of said rings,
wherein when said inner compression band is released, said second ring separates from said first ring along a cylindrical axis of said rings, and
wherein the number of said spaced voussoirs on each of said rings are equal to half of the number of said bolt holes in each of said rings.

2. The satellite separation system of claim 1, wherein said plurality of second bolt holes are arranged at equal angular intervals for attachment to a payload.

3. The satellite separation system of claim 1, wherein said plurality of first bolt holes are circumferentially arranged at equal angular intervals for attachment to a launch vehicle.

4. The satellite separation system of claim 1, wherein each of said rings comprises cups and cones.

5. The satellite separation system of claim 4, wherein said cups and cones provide shear force transmission along a linear axis between said rings.

6. The satellite separation system of claim 1, wherein an angular width of each of said spaced voussoirs is equal to 360/(number of said bolt holes*0.5) degrees.

7. The satellite separation system of claim 1, further comprising:
a radial gear motor configured to drive a screw into engagement with a toggle assembly, said toggle assembly expanding said inner compression band,
wherein actuation of said radial gear motor retracts said screw to release compression on said inner compression band causing said inner compression band to contract and release said second ring from said first ring.

8. The satellite separation system of claim 1, further comprising:
at least three linear bearing guide rods located in said second ring and slidably received in corresponding linear bearings in said first ring,
said linear bearing guide rods and said linear bearings being equally spaced around the periphery of said first ring and said second ring to prevent tipping and jamming therebetween.

9. A satellite separation system, said satellite separation system comprising in combination:
a stay-behind ring comprising a plurality of first bolt holes circumferentially arranged at equal angular intervals for attachment to a launch vehicle;
a flyaway ring comprising a plurality of second bolt holes circumferentially arranged at equal angular intervals for attachment to a payload; and
an inner compression band;
said stay-behind ring comprises a set of spaced voussoirs arranged in a circular arch,
wherein said flyaway ring comprises a set of spaced voussoirs arranged in a circular arch,
wherein said spaced voussoirs of said stay-behind ring interleave with said flyaway ring spaced voussoirs,
said inner compression band is positioned on an internal diameter between said stay-behind ring and said flyaway ring and compresses said voussoirs together to prevent separation of said rings,
wherein when said inner compression band is released, said flyaway ring separates from said stay-behind ring along a cylindrical axis of said rings,
wherein the number of said spaced voussoirs on each of said rings are equal to half of the number of said bolt holes in each of said rings, and
wherein an angular width of each of said spaced voussoirs is equal to 360/(number of said bolt holes*0.5) degrees.

10. The satellite separation system of claim 9, wherein each of said rings comprises cups and cones.

11. The satellite separation system of claim 10, wherein said cups and cones provide shear force transmission along a linear axis between said rings.

12. The satellite separation system of claim 9, further comprising:
a radial gear motor configured to drive a screw into engagement with a toggle assembly, said toggle assembly expanding said inner compression band,
wherein actuation of said radial gear motor retracts said screw to release compression on said inner compression band causing said inner compression band to contract and release said flyaway ring from said stay-behind ring.

13. The satellite separation system of claim 9, further comprising:
at least three linear bearing guide rods located in said flyaway ring and slidably received in corresponding linear bearings in said stay-behind ring,
said linear bearing guide rods and said linear bearings being equally spaced around the periphery of said stay-behind ring and said flyaway ring to prevent tipping and jamming therebetween.

14. The satellite separation system of claim 9, wherein said inner compression band includes chamfered surfaces configured to seat against chamfered cutouts on an inner diameter of said spaced voussoirs.

15. A method of providing a satellite separation system, said method comprising the steps of:
providing a first ring comprising a plurality of first bolt holes;
providing a second ring comprising a plurality of second bolt holes;
providing an inner compression band;
arranging a set of spaced voussoirs comprised in said first ring in a circular arch;
arranging a set of spaced voussoirs comprised in said second ring in a circular arch;
configuring the number of said spaced voussoirs on each of said rings to be equal to half of the number of said bolt holes in each of said rings;
configuring said spaced voussoirs of said first ring to interleave with said second ring spaced voussoirs;
positioning said inner compression band on an internal diameter between said first ring and said second ring and compressing said voussoirs together to prevent separation of said rings; and
releasing said inner compression band such that said second ring separates from said first ring along a cylindrical axis of said rings.

16. The method of claim 15, further comprising providing cups and cones on each of said rings such that said cups and cones provide shear force transmission along a linear axis between said rings.

17. The method of claim 15, further comprising configuring an angular width of each of said spaced voussoirs to be equal to 360/(number of said bolt holes*0.5) degrees.

18. The method of claim 15, further comprising introducing a draft angle between opposing faces of said spaced voussoirs to enable separation of said spaced voussoirs.

19. The method of claim 15, further comprising:
providing a radial gear motor configured to drive a screw into engagement with a toggle assembly, said toggle assembly expanding said inner compression band, and
actuating said radial gear motor to retract said screw to release compression on said inner compression band causing said inner compression band to contract and release said second ring from said first ring.

20. The method of claim 15, further comprising:
providing at least three linear bearing guide rods located in said second ring and slidably received in corresponding linear bearings in said first ring, said linear bearing guide rods and said linear bearings being equally spaced around the periphery of said first ring and said second ring to prevent tipping and jamming therebetween.
